(19) United States
(12) Patent Application Publication
(10) Pub. No.: US 2012/0056842 A1
(43) Pub. Date: Mar. 8, 2012

(54) Sensing Apparatus for Touch Panel and Sensing Method Thereof

(75) Inventor: Yaw-Guang Chang, Sinshih Township (TW)

(73) Assignee: HIMAX TECHNOLOGIES LIMITED, Sinshih Township (TW)

(21) Appl. No.: 12/874,428

(22) Filed: Sep. 2, 2010

(51) Int. Cl. G06F 3/045; G08C 21/00

(52) U.S. Cl. 345/174; 178/18.06

(57) ABSTRACT

A sensing apparatus for a touch panel includes: sensitive capacitors formed between intersections of first electrodes and the second electrodes; a first sensing circuit, for positioning two locations of the first electrodes by sensing changed capacitance values of the sensitive capacitors corresponding to the two locations of the first electrodes; a second sensing circuit, for positioning two locations of the second electrodes by two objects by sensing changed capacitance values of the sensitive capacitors corresponding to the two locations of the second electrodes; and a third sensing circuit for sequentially positioning two locations of the scanned electrodes by sensing changed capacitance values of the sensitive capacitors corresponding to the two locations of the scanned electrodes, wherein a control circuit determines the two touch points according to the two locations of the first electrodes, and the two locations of the second electrodes and the two locations of the scanned electrodes.

### FIELD OF THE INVENTION

The present invention relates to a sensing apparatus and in particular relates to a sensing apparatus for a touch panel and sensing method thereof.

### DESCRIPTION OF THE RELATED ART

Touch sensitive devices allow a user to conveniently interface with electronic systems and displays by reducing or eliminating the need for mechanical buttons, keypads, keyboards, and pointing devices. For example, a user can carry out a complicated sequence of instructions by simply touching an on-display touch screen at a location identified by an icon.

There are several types of technologies for implementing a touch sensitive device including, for example, resistive, infrared, capacitive, surface acoustic wave, electromagnetic, and near field imaging technology, etc. Capacitive touch sensing devices have been found to work well for a number of applications. In many touch sensitive devices, an input is sensed when a conductive object in the sensor is capacitively coupled to a conductive touch implement such as a user's finger. Generally, whenever two electrically conductive members come into proximity with one another without actually touching, their electric fields interact to form capacitance. In the case of a capacitive touch sensitive device, as an object such as a finger approaches the touch sensing surface, a tiny capacitance forms between the object and the sensing points in close proximity to the object. By detecting changes in capacitance at each of the sensing points and noting the position of the sensing points, the sensing circuit can recognize multiple objects and determine the characteristics of the object (such as location, pressure, direction, speed, acceleration, and so forth) as it is moved across the touch surface.

However, when two fingers approach the touch sensing surface at the same time, a sensing apparatus of the capacitive touch sensitive device may not accurately detect two sensing points at the moment of approach. Instead, four sensing points (there are two so-called ghost points) are detected as FIG. 1a shows. A first sensing circuit 110 and a second sensing circuit 120 respectively sense two changes in capacitance at two sensing points along two different axes on the touch sensing surface. Accordingly, there are four possible sensing points sensed by the capacitive touch sensitive device.

The above capacitive touch sensitive device is also referred to as a self capacitor touch sense device. Another capacitive touch sensitive device shown in FIG. 1b is known as a mutual capacitor touch sense device. The mutual capacitor touch sense device 150 has a scan drive circuit 160, a sensing circuit 170 and an analog to digital converter 180. For example, the scan drive circuit 160 scans first electrodes arranged along Y axis, wherein the sensing circuit 170 along the X axis senses changes in capacitance corresponding to the scanned first electrodes. The analog to digital converter 180 transforms the sensed analog signals from the sensing circuit 170 into digital signals. Hence the mutual capacitor touch sense device 150 may need much time to sense the two sensing points because it always has to take 2 ms*8=16 ms (there are 8 rows of electrodes respectively along x axis and y axis) to accurately scan and sense the two sensing points but the self capacitor only takes 2 ms*2=4 ms to scan and sense the two sensing points. Furthermore, the mutual capacitor touch sense device may also occupy more storage capacity because a lot of sensed results (about cost 8*8*16=1024 bits) need to be stored when the electrodes are being scanned and sensed.

Thus, a sensing apparatus that is able to accurately eliminate ghost points and detect the actual two touch points with less time and less storage space is called for.

### BRIEF SUMMARY OF INVENTION

A detailed description is given in the following embodiments with reference to the accompanying drawings.

The present invention provides a sensing apparatus for a touch panel, adapted to sense two touch points on the touch panel when the touch panel is being touched with two objects. The sensing apparatus for a touch panel comprises: a plurality of first electrodes formed along a first axis; a plurality of second electrodes formed along a second axis; a plurality of sensitive capacitors formed between intersections of the first electrodes and the second electrodes, wherein capacitance values of the sensitive capacitors are changed when the touch panel is touched with objects; a first sensing circuit, for positioning two locations of the first electrodes touched by two objects by sensing changed capacitance values of the sensitive capacitors corresponding to the two locations of the first electrodes; a second sensing circuit, for positioning two locations of the second electrodes by two objects by sensing changed capacitance values of the sensitive capacitors corresponding to the two locations of the second electrodes, while being synchronously operated? with the first sensing circuit; a scan driving circuit for sequentially scanning one of the first electrodes and the second electrodes; and a third sensing circuit for sequentially positioning two locations of the scanned electrodes touched by the two objects by sensing changed capacitance values of the sensitive capacitors corresponding to the two locations of the scanned electrodes; and a control circuit for determining the two touch points according to the two locations of the first electrodes, and the two locations of the second electrodes and the two locations of the scanned electrodes.

The present invention provides a sensing method for a touch panel, adapted to sense two touch points when the touch panel is being touched with two objects, wherein a plurality of sensitive capacitors are formed between intersections of a plurality of first electrodes and the second electrodes, and capacitance values of the sensitive capacitors are changed when the touch panel is touched with objects. The method comprises: positioning two locations of the first electrodes touched by two objects by sensing changed capacitance values of the sensitive capacitors corresponding to the two locations of the first electrodes by a first sensing circuit; positioning two locations of the second electrodes by two objects by sensing changed capacitance values of the sensitive capacitors corresponding to the two locations of the second electrodes by the second sensing circuit, while being synchronously operated? with the first sensing circuit; sequentially scanning one of the first electrodes and the second electrodes by a scan driving circuit; and sequentially positioning two locations of the scanned electrodes touched by the two objects by sensing changed capacitance values of the sensitive capacitors corresponding to the two locations of the scanned electrodes by a third sensing circuit; and determining the two touch points according to the two locations of the first electrodes, and the two locations of the second electrodes and the two locations of the scanned electrodes by a control circuit.

The above-mentioned sensing apparatus for a touch panel and sensing method thereof not only eliminates undesired ghost points but may also being implemented with higher operating speeds and lower storage costs.

### BRIEF DESCRIPTION OF DRAWINGS

The present invention can be more fully understood by reading the subsequent detailed description and examples with references made to the accompanying drawings, wherein:

FIG. 1a is a diagram showing a conventional sensing apparatus for a touch panel;

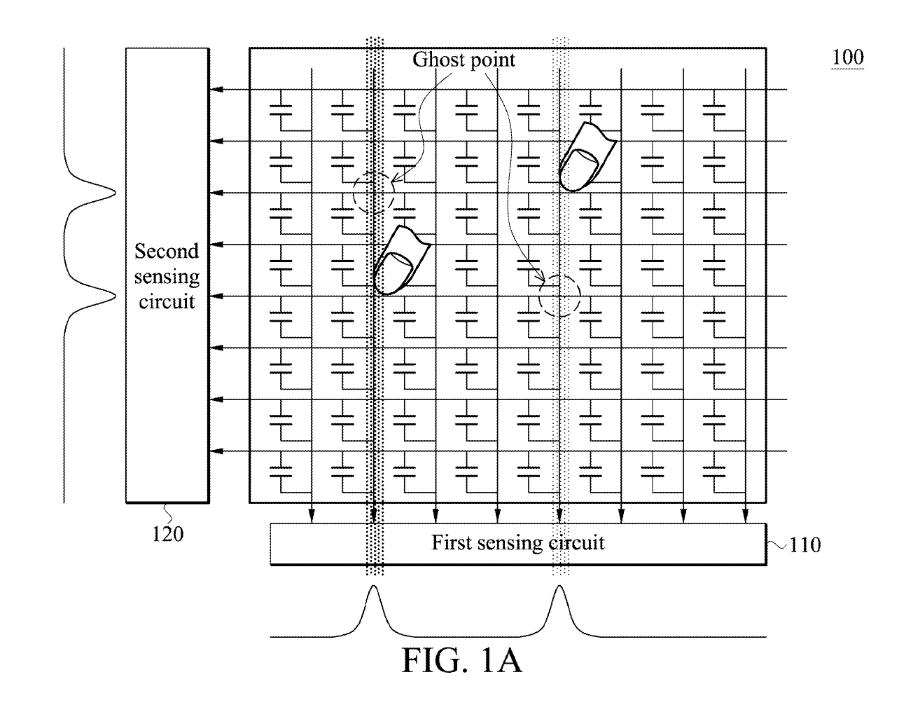

FIG. 1b is a diagram showing another conventional sensing apparatus for a touch panel;

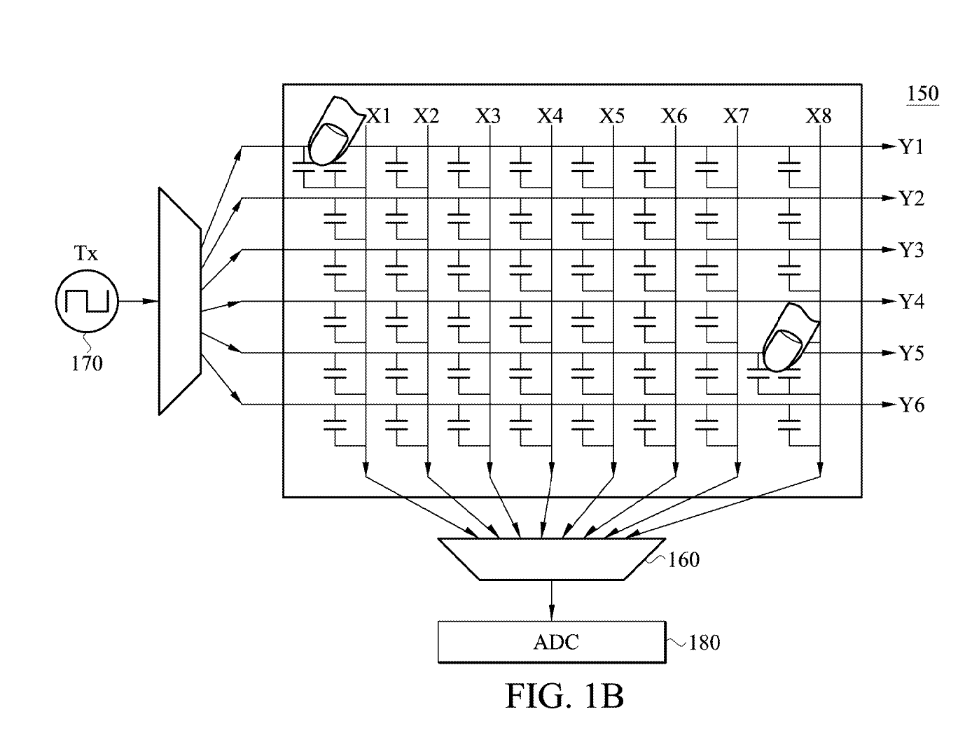

FIG. 2 is a diagram showing a sensing apparatus for a touch panel of the invention; and

FIG. 3 is a flowchart illustrating a sensing method for a touch panel according to an embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

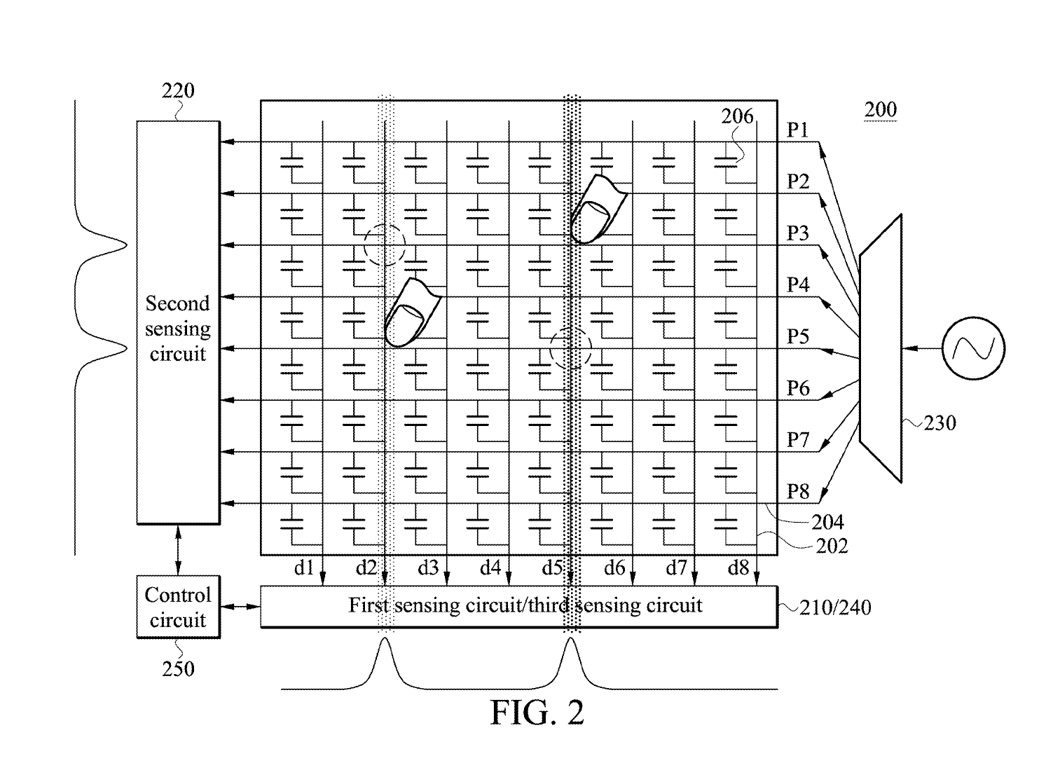

FIG. 2 is a diagram showing a sensing apparatus for a touch panel of the invention. The sensing apparatus 200 includes a plurality of first electrodes 202 (e.g. d1-d8), a plurality of second electrodes 204 (e.g. p1-p8), a first sensing circuit 210, a second sensing circuit 220, a scan driving circuit 230 and a third sensing circuit 240. The third sensing circuit 240 may be a low resolution analog to digital converter, but is not limited thereto.

A plurality of first electrodes 202 is formed along a first axis and a plurality of second electrodes 204 is formed along a second axis. A plurality of sensitive capacitors 206 is therefore formed between intersections of the first electrodes and the second electrodes. Capacitance values of the sensitive capacitors are changed when the touch panel is touched with objects or fingers. A first sensing circuit 210 is used to position two locations of the first electrodes touched by two objects by sensing changed capacitance values of the sensitive capacitors corresponding to the two locations of the first electrodes. A second sensing circuit 220 is used to position two locations of the second electrodes by two objects by sensing changed capacitance values of the sensitive capacitors corresponding to the two locations of the second electrodes, and the first sensing circuit 210 is synchronously activated with the first sensing circuit 220. That is, the first sensing circuit 210 and the second sensing circuit 220 may sense the touch points on the touch panel simultaneously.

A scan driving circuit 230 is used to sequentially scan one of the first electrodes and the second electrodes. A third sensing circuit 240 is used to sequentially position two locations of the scanned electrodes touched by the two objects by sensing changed capacitance values of the sensitive capacitors corresponding to the two locations of the scanned electrodes. When the scan driving circuit 230 scans the first electrodes (a test signal is sequentially delivered to the second electrodes p1-p8), then the third sensing circuit 240 senses the first electrodes (d1-d8). The third sensing circuit 240 may be integrated into the first sensing circuit 210. Relatively, when the scan driving circuit 230 scans the second electrodes (a test signal is sequentially delivered to the first electrodes d1-d8), then the third sensing circuit 240 senses the second electrodes (p1-p8). The third sensing circuit 240 may be integrated into the second sensing circuit 220.

A control circuit 250 is used to determine the two touch points according to the two locations of the first electrodes, and the two locations of the second electrodes and the two locations of the scanned electrodes. The control circuit 250 is further used to control the first sensing circuit 210, the second sensing circuit 220, the scan drive circuit 230, and the third sensing circuit 240.

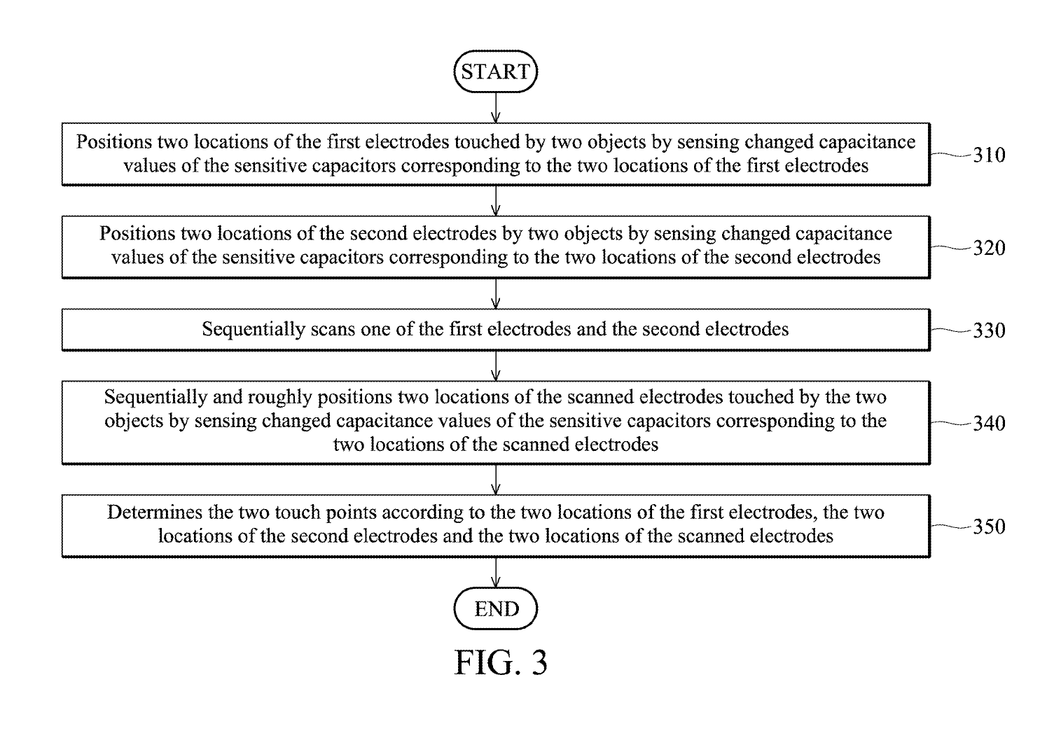

FIG. 3 is a flowchart illustrating a sensing method for a touch panel according to an embodiment of the invention. The sensing method for a touch panel is adapted to sense two touch points when the touch panel is being touched with two objects. At the beginning, the first sensing circuit of the touch panel may position two locations of the first electrodes touched by two objects by sensing changed capacitance values of the sensitive capacitors corresponding to the two locations of the first electrodes in step 310. Next, in step 320, the second sensing circuit of the touch panel may position two locations of the second electrodes by two objects by sensing changed capacitance values of the sensitive capacitors corresponding to the two locations of the second electrodes, while being synchronously activated with the first sensing circuit. In step 330, the scan drive circuit may sequentially and quickly scan (not have to accurately scan) one of the first electrodes and the second electrodes. Next, the third sensing circuit of the touch panel may sequentially and roughly (i.e. low revolution) position two locations of the scanned electrodes touched by the two objects by sensing changed capacitance values of the sensitive capacitors corresponding to the two locations of the scanned electrodes by a third sensing circuit in step 340. Finally, the two touch points may be determined according to the two locations of the first electrodes, the two locations of the second electrodes and the two locations of the scanned electrodes in step 350.

In one embodiment of the invention, there are four possible touch points according to the two locations of the first electrodes, and the two locations of the second electrodes. Because the first sensing circuit and the second sensing circuit are operated simultaneously, the two sensing circuits senses four touch points including two ghost points at the same time. In order to exclude the two ghost points. For example, the first electrodes may be sequentially and roughly scanned with a test signal by the scan drive circuit and then the capacitance values of the sensitive capacitors corresponding to the scanned first electrodes which have changed may be roughly sensed by the third sensing circuit. So, two possible touch points may be further verified according to the two locations of the scanned first electrodes. For example, when each row of the first electrodes is quickly scanned for less than 0.2 ms, then the total scanned and sensed time for the third sensing circuit is 0.2 m*8=1.6 m (assume total row number of a first electrodes is 8), which is less than the conventional mutual capacitor touch sense device. Therefore, a low revolution analog to digital converter with capacity 8*8*8 bits (512 bits) is sufficient for use in the invention.

Furthermore, in the embodiment of the invention, the changed capacitance values of the sensitive capacitors become larger when the corresponding locations of the electrodes are touched. Usually, a threshold capacitance value is set by users to determine the sensitivity of the touch panel. That is, when the threshold capacitance value is small, a small change in capacitance values can trigger the sensing circuit to recognize the touch points.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sensing apparatus for a touch panel, adapted to sense two touch points on the touch panel when the touch panel is being touched with two objects, comprising:
a plurality of first electrodes formed along a first axis;
a plurality of second electrodes formed along a second axis;
a plurality of sensitive capacitors formed between intersections of the first electrodes and the second electrodes, wherein capacitance values of the sensitive capacitors are changed when the touch panel is touched with objects;
a first sensing circuit, for positioning two locations of the first electrodes touched by two objects by sensing changed capacitance values of the sensitive capacitors corresponding to the two locations of the first electrodes;
a second sensing circuit, for positioning two locations of the second electrodes by two objects by sensing changed capacitance values of the sensitive capacitors corresponding to the two locations of the second electrodes, while being synchronously activated with the first sensing circuit;
a scan driving circuit for sequentially scanning one of the first electrodes and the second electrodes; and
a third sensing circuit for sequentially positioning two locations of the scanned electrodes touched by the two objects by sensing changed capacitance values of the sensitive capacitors corresponding to the two locations of the scanned electrodes,
wherein the two touch points are determined according to the two locations of the first electrodes, and the two locations of the second electrodes and the two locations of the scanned electrodes.

2. The apparatus as claimed in claim 1, wherein the first sensing circuit and the third sensing circuit are integrated together or the second sensing circuit and the third sensing circuit are integrated together.

3. The apparatus as claimed in claim 1, further comprising a control circuit, for controlling the first sensing circuit, the second sensing circuit, the third sensing circuit and the scan driving circuit.

4. The apparatus as claimed in claim 1, wherein the first sensing circuit, the second sensing circuit, and the third sensing circuit further include analog to digital converters.

5. The apparatus as claimed in claim 4, wherein the analog to digital converter in the third sensing circuit is a low resolution analog to digital converter.

6. A sensing method for a touch panel, adapted to sense two touch points when the touch panel is being touched with two objects, wherein a plurality of sensitive capacitors are formed between intersections of a plurality of first electrodes and the second electrodes, and capacitance values of the sensitive capacitors are changed when the touch panel is touched with objects, comprising:
positioning two locations of the first electrodes touched by two objects by sensing changed capacitance values of the sensitive capacitors corresponding to the two locations of the first electrodes by a first sensing circuit;
positioning two locations of the second electrodes by two objects by sensing changed capacitance values of the sensitive capacitors corresponding to the two locations of the second electrodes by a second sensing circuit, while being synchronously activated with the first sensing circuit;
sequentially scanning one of the first electrodes and the second electrodes by a scan driving circuit; and
sequentially positioning two locations of the scanned electrodes touched by the two objects by sensing changed capacitance values of the sensitive capacitors corresponding to the two locations of the scanned electrodes by a third sensing circuit;
determining the two touch points according to the two locations of the first electrodes, and the two locations of the second electrodes and the two locations of the scanned electrodes by a control circuit.

7. The method as claimed in claim 6, wherein determining the two touch points comprises:
obtaining four possible touch points according to the two locations of the first electrodes, and the two locations of the second electrodes; and
verifying two possible touch points according to the two locations of the scanned electrodes.

8. The method as claimed in claim 6, wherein the changed capacitance values are larger than a threshold capacitance value.

9. The method as claimed in claim 6, wherein the threshold capacitance value is set by users and determines touch sensitivity of the sensing method.

10. The method as claimed in claim 6, wherein scanning time for scanning each row of one of the first electrodes and the second electrodes is less than 0.2 ms.
